(19) United States
(12) Patent Application Publication
(10) Pub. No.: US 2016/0048376 A1
(43) Pub. Date: Feb. 18, 2016

(54) PORTABLE BINARY IMAGE FORMAT (PBIF) FOR PRE-COMPILED KERNELS

(71) Applicant: Advanced Micro Devices, Inc., Sunnyvale, CA (US)

(72) Inventor: Srinivasulu CHARUPALLY, Hyderabad (IN)

(73) Assignee: Advanced Micro Devices, Inc., Sunnyvale, CA (US)

(21) Appl. No.: 14/457,561

(22) Filed: Aug. 12, 2014

(51) Int. Cl. G06F 9/45; G06F 9/455

(52) U.S. Cl. CPC G06F 8/41; G06F 9/45533

(57) ABSTRACT

Embodiments include methods, systems, and computer-readable medium directed to a compiler for compiling a portable binary image. The compiler compiles a program source code into a first executable specific to a first instruction set architecture (ISA). The compiler then compiles the program source code into a code generator output. Additionally the compiler combines the executable and the code generator output into a portable binary image. At runtime on a target device, the code generator output can be compiled into a second executable in accordance to a second ISA specific to the target device if the originally compiled first executable specific to the first ISA is not executable on the target device.

### BACKGROUND

1. Field

The present disclosure relates to the process of compiling and executing a computer program. More specifically, the present disclosure relates to a method for improving the portability of compiled binary images across different types of processors.

2. Background Art

Open Computing Language (OpenCL™) is a framework that offers developers the ability to write C-like programs that execute across different processor types, including central processing units (CPUs), graphics processing units (GPUs), accelerated processing units (APUs), and other processors. The OpenCL framework provides a programming standard for general-purpose computations on heterogeneous systems.

The OpenCL framework usually provides a compiler that can compile a program source code into an OpenCL binary image (often called a kernel) on a development device. The OpenCL framework also provides a runtime environment that can execute an OpenCL binary image (i.e., the kernel) on a target device. An embedded Just In Time (JIT) compiler often comes with the OpenCL runtime that can compile the OpenCL source code in the image at execution time.

OpenCL offers two compilation design flows. The first compilation flow is offline compilation. Offline compilation involves compiling the source code on the development device into a generated binary image (i.e., kernel) and passing the binary image to the OpenCL runtime on the target device for execution.

The second compilation flow is online compilation. Online compilation involves passing the OpenCL source code to the runtime on a target device, and the embedded MT compiler in the OpenCL runtime will compile the source code at run time before execution. For independent software vendors and other developers concerned with making the source code of OpenCL kernels available to the end users on the target device, the first compilation flow, offline compilation, is the preferred method because it hides the source code from the end users.

However, offline compilation has its own limitations. First, the generated binary image from offline compilation is not portable across multiple types of target device processors. For example, some current OpenCL offline compiler implementations on the market support a single GPU/CPU/APU as the target device processor for the generated binary image. The generated binary image works only for that device processor type. Second, if the source code contains a large number of lines of source code, compilation time by the JIT compiler on the target device might be unacceptably long for the end users.

### BRIEF DESCRIPTION OF THE DRAWINGS/FIGURES

The accompanying drawings, which are incorporated herein and form part of the specification, illustrate the disclosed embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

FIG. 1 is a block diagram of a binary image generated by a conventional OpenCL compilation process, in accordance with embodiments.

FIG. 2 is a block diagram of a portable binary image generated in accordance with embodiments.

FIG. 3 is a flowchart illustrating an exemplary compiling process of an OpenCL source code on a development device, in accordance with embodiments.

FIG. 4 is a flowchart illustrating the execution of a portable binary image on a target device, in accordance with embodiments.

FIG. 5 is a block diagram of an exemplary electronic device where embodiments may be implemented.

The features and advantages of the disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “embodiments” does not require that all embodiments include the discussed feature, advantage or mode of operation. Alternate embodiments may be devised without departing from the scope of the disclosure, and well-known elements may not be described in detail or may be omitted so as not to obscure the relevant details. In addition, the terminology used herein is for the purpose of describing particular embodiments only and is not intended to be limiting. For example, as used herein, the singular forms “a”, “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

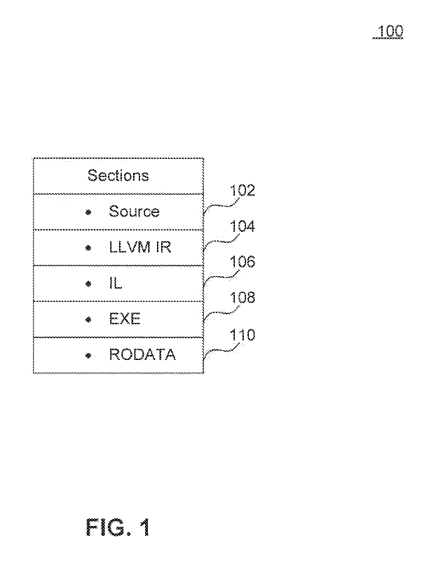

FIG. 1 is a block diagram of a binary image generated by a conventional OpenCL compilation process, in accordance with an embodiment. By way of non-limiting example, the binary image of FIG. 1 uses AMD BIF (Binary Image Format) 2.0. BIF 2.0 is a binary image format used in the AMD OpenCL implementation. BIF 2.0 has an IL (intermediate language) section which works only for a specific target device processor. By way of non-limiting example, the IL section could contain AMD IL. Executing the binary image in BIF 2.0 format on different types of target device processors requires recompilation of the given OpenCL source/kernel.

In FIG. 1, an example OpenCL compiled image 100 in BIF 2.0 format includes five sections: source section 102, LLVMIR section 104, IL section 106, exe section 108, and rodata section 110.

Source section 102 contains OpenCL source code in text.

LLVMIR section 104 contains low level virtual machine immediate representation (LLVM IR) for the given OpenCL source program. On the target device, OpenCL uses a low level virtual machine (LLVM) as its underlying compiler. Thus, LLVM's immediate representation (IR) is used as its immediate representation for the OpenCL source program. The LLVM IR that is to be stored in the generated binary image is un-optimized. The LLVM IR enables recompilation from LLVM IR to the target device. However, the LLVM IR itself is platform-specific. When a binary is used to run on a device for which the original program was not generated and the original device is feature-compatible with the current device, OpenCL recompiles the LLVM IR to generate a new code for the device. Note that the LLVM IR is only universal within devices that are feature-compatible in the same device type, not across different device. For example, a LLVM IR for CPU only works on CPUs that have equivalent feature sets on target devices, and a LLVM IR for GPU only works on GPUs that have equivalent feature sets on target devices.

IL section 106 contains the IL program text for the given OpenCL source program, and it is for GPU only. By way of non-limiting example, the IL section could contain AMD IL. This section is ignored by the CPU on the target device. It is generated by LLVM's IL code generator (codegen or CG). The immediate language program text generated by the codegen has the IL and its metadata. The IL is stored in IL section 106 and metadata in rodata section 110. IL and its metadata are stored in terms of symbols. Rodata section 110 holds symbols for various stages of compilation. When a binary is created, the rodata section will hold two symbols, _ISA_<func>_metadata and _OpenCL_<N>_global. _ISA_<func>_metadata holds the binary blob that gives all the register setup that is required by the hardware. The second symbol _OpenCL_N>_global defines the data that is to be stored in the constant buffers on the GPU device. The number N maps the data to the constant buffer.

Exe section 108 contains the executable for the given OpenCL source program. The executable is coded in accordance to an instruction set architecture (ISA) specific to a processor type. For a CPU on a target device, the executable is the dynamic link library (DLL). For a GPU on a target device, the executable is the CALimage. The executable is stored in exe section 108 in terms of symbols.

On the target device that executes the compiled image in BIF 2.0 format, if image 100 already has the executable, OpenCL runtime on the target device will check if the executable matches the target device exactly, if so, the runtime runs the executable and no recompilation needed. Otherwise, if the binary is recompilable, the Stream SDK associated with the runtime will recompile the OpenCL source in image 100 to generate the new executable for the target device, and then the runtime will run the new executable on the target device.

Although the current compiler allows the source code to be compiled into LLVMIR 104 in image 100, it does not provide enough flexibility when dealing with multiple device types. The current Stream SDK on the target device provides capability to recompile LLVMIR 104 on the target device, provided that image 100 is recompilable. Image 100 is recompilable if image 100's bitness matches the host application's bitness and image 100's platform matches the target device's platform. A host application is an software application that runs on a CPU or a GPU on the target device. The host application can access the functionalities provided by image 100. Bitness match means, for example, that a 32-bit image works only on a 32-bit operating system, and a 64-bit image works only on a 64-bit operating system. Platform match means that an image generated for CPU works only on CPU on the target device and an image generated on GPU works only on GPU on the target device.

With the conventional compiling methods such as the one that generates images in BIF 2.0 format, each generated binary image is supported only on the OpenCL, devices that it was originally generated for. Attempting to load a binary image onto an OpenCL target device for which it was not originally generated for may result in undefined behavior. Another problem with the conventional compiling methods is that in order to execute the program on various platforms, multiple kernel binaries must be included, thus increasing the size of the executable file.

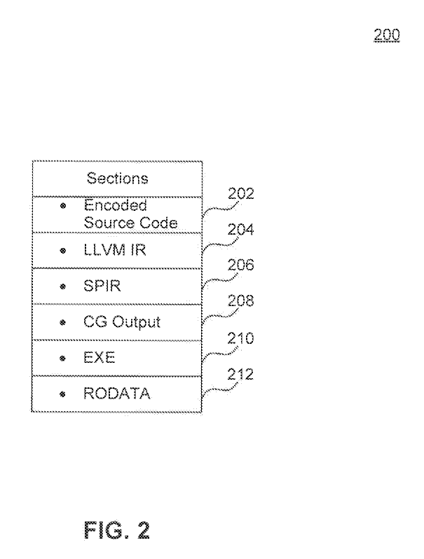

FIG. 2 is a block diagram of a portable binary image generated in accordance with some embodiments. The portable binary image splits one section into multiple sections so that the same portable binary image can be executed on multiple platforms or devices. The portable binary image is more flexible to the compiler library on the target device. It also allows compatibility and drops duplicate sections that are no longer required or desired (i.e. the IL section). The binaries required by the compiler library have more requirements than what OpenCL only requires.

In FIG. 2, an exemplary portable binary image 200 includes five sections: encoded source code 202, LLVMIR 204, SPIR 206, CG Output 208, exe 210, and rodata 212.

Encoded source code section 202 is a special section of the portable binary image and contains the encoded form of the source code. The entire source section is unstructured and is a sequence of encoded characters. According to one embodiment, the encoded source code is only stored in the binary format for the sake of recompilation from the source.

LLVMIR section 204 contains the low level virtual machine immediate representation (LLVM IR). LLVM IR is in the binary format, and LLVM IR for the entire program is stored to or read from LLVMIR section 204 as a sequence of bytes.

LLVM IR is platform. specific, and thus IR for CPU is incompatible with IR for GPU. However, IR for GPU is valid for all GPU devices that have the same capabilities. And IR for CPU is valid for all CPU variants, assuming that the IR's bitness matches the bitness of the host application on the target device.

SPIR section 206 contains standard portable intermediate representation (SPIR). SPIR for the entire program is stored to or read from SPIR section 206 as a sequence of bytes. SPIR provides one more intermittent representation of the source code. SPIR can be compiled from program source code. on the development device. SPIR blobs must be converted to LLVM-IR before being consumed by low level virtual machine on the target. device. The final definition of this section is dependent on what is adopted as the official SPIR spec by OpenCL Working Group.

CG output section 208 contains the output of the code generator (CG) for the respective devices. Current BIF 2.0 CG is only for GPU devices. It's called as IL codegen. The CG output is only valid for the GPU. The CG output is ignored if the device. type is CPU. In contrast to IL in BIF 2.0. The code generator for PBIF has capability to generate output for both CPU and GPU. The code generator generates output by compiling the LLVM IR. CO output on the CPU is the x86 assembly code, and CC output on the CPU is an IL string or an HSAIL string based on the target family. CO output section 208 contains a few symbols, which map to device specific features. When a device is generated for a CPU, three symbols are created, _OpenCL_<time>_[kernel|metadata|stub] which map to the metadata kernel and stub for each function/kernel for the CPU. For the IL/HSAIL device, CG output section 208 contains a text blob which has a structure that is defined outside portable binary image specification.

Exe section 210 will hold the executable binary. On the CPU, the executable binary is a x86 binary, and for IL targets, this is the executable encoded in accordance to the GPU ISA. Each kernel that is created for the binary will be stored with the symbol _ISA_<kernel>_binary. This is the raw binary that will be executed on each device.

Rodata 212 section holds symbols for various stages of compilation. When a binary is created, the rodata section will hold two symbols, _ISA_<func>_metadata and _OpenCL_<N>_global. _ISA_<func>_metadata holds the binary blob that gives all the register setup that is required by the hardware. The second symbol _OpenCL_<N>_global defines the data that is to be stored in the constant buffers on the GPU device. The number <N> in _OpenCL_<N>_global maps the data to the constant buffer.

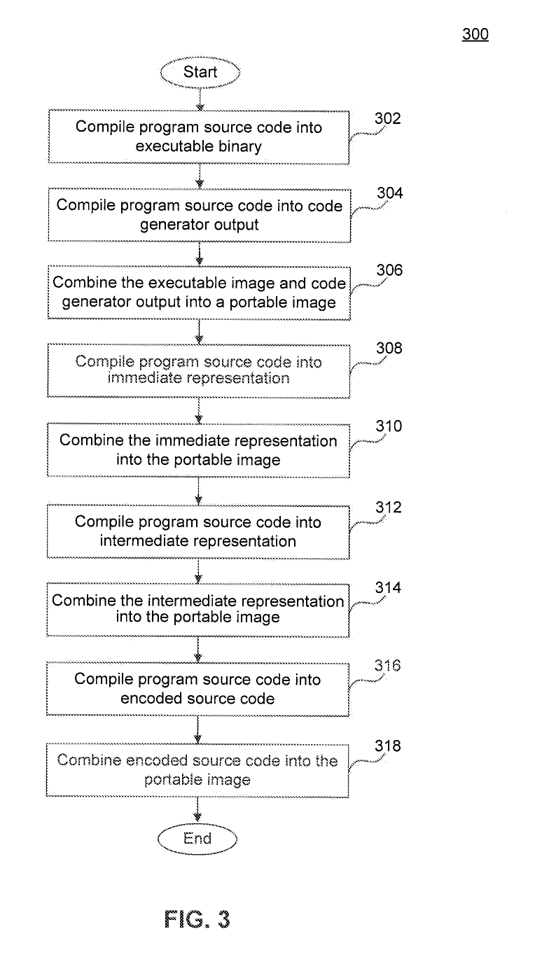

FIG. 3 illustrates a flowchart of a method 300 for a compiler on the development device for compiling the program source code into the portable binary image, according to some embodiments. Method 300 compiles program source code such that the generated portable image can execute on one or more of CPU, GPU, APU or other processors on different types of devices. In some embodiments, the portable binary image is executed through a runtime on a target device. The compiler on the development device can analyze the code (e.g. in source code form or in an intermediate binary code form) and convert the code into the executable binary or another intermediate binary code. In one example, method 300 generates the portable image in the format as described above in FIG. 2. It is to be appreciated that method 300 may not be executed in the order shown or require all operations shown.

At operation 302, the compiler on the development device compiles the program source code into an executable binary. In an embodiment, the program source code is OpenCL program source code, in another embodiment, the executable binary can be executed by the runtime on a target device.

At operation 304, the compiler on the development device compiles the program source code into a code generator output. In an embodiment, the compiler compiles the OpenCL program source code into LLVM IR first, and LLVM IR is then compiled into the code generator output. In another embodiment, the code generator can be compiled into another executable binary by a JIT compiler associated with a runtime on a target device.

At operation 306, the generated executable binary and the code generator output are combined into the portable binary image. In one embodiment, the executable binary is placed in exe section 210 of portable binary image 200, and the code generator output is placed in CG output section 208.

At operation 308, the compiler on the development device compiles the program source code into an immediate representation. In one embodiment, the immediate representation is LLVM IR.

At operation 310, the generated immediate representation is combined into the portable binary image. In one embodiment, the immediate representation is placed in LLVMIR section 204 of portable binary image 200.

At operation 312, the compiler on the development device compiles the program source code into an intermediate representation. In one embodiment, the intermediate representation is SPIR. In another embodiment, SPIR can be compiled into LLVM IR.

At operation 314, the generated SPIR is combined into the portable binary image. In one embodiment, the generated SPIR is placed in SPIR section 206 of portable binary image 200.

At operation 316, the compiler on the development device compiles the program source code into an encoded source code. The encoded source code is an encoded sequence of character representing the program source code. The JIT compiler on a target device can re-compile the encoded source code the same as it compiles a program source code in text format. However, according to one non-limiting embodiment, the encoded source code is encoded in the binary format such that it is not readable to end users.

At operation 318, the generated encoded source code is combined into the portable binary image. In one embodiment, the generated encoded source code is placed in encoded source code section 202 of portable image 200.

Portable binary image generated by method 300 provides capabilities to execute the same binary image across multiple devices, provided that the binary is recompilable by the JIT compiler on the target device.

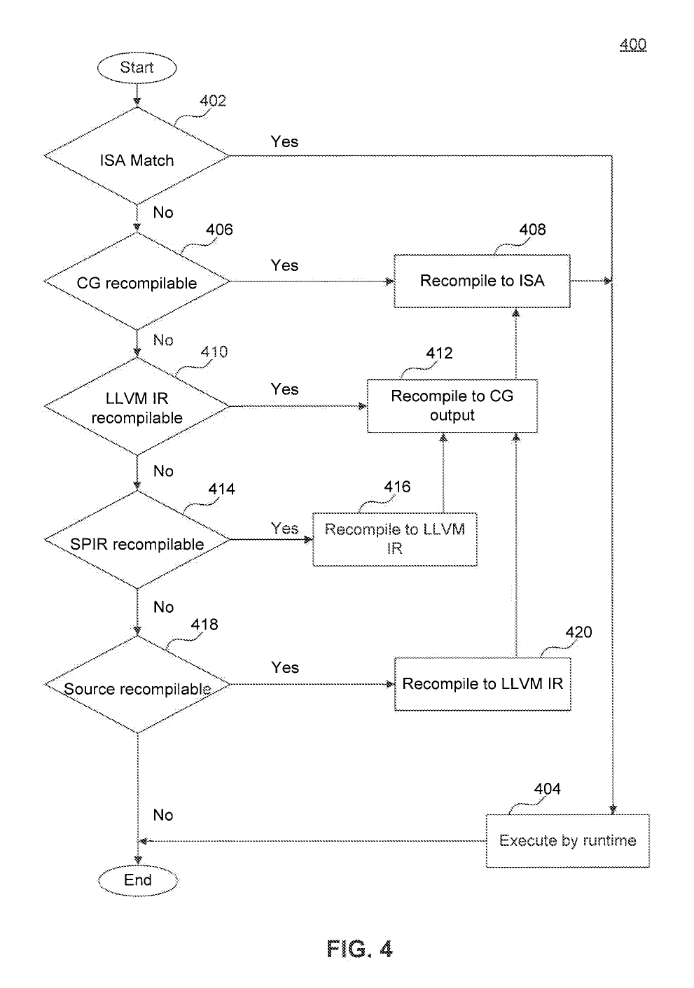

FIG. 4 is a flowchart illustrating the execution of a portable binary image on a target device, according to some embodiments. In some embodiments, the portable binary image is executed through a runtime on the target device. In one example, method 400 loads a portable binary image in the format as described in FIG. 2. It is to be appreciated that method 400 may not be executed in the order shown or require all operations shown.

According to some embodiments, two additional conditions (not shown in FIG. 4) must be satisfied before any scenario described below to work. First, the bitness of the portable binary image must match the bitness of the host application running on the target device processor. Second, the portable binary image's platform must match the target device processor's platform. That means, for example, an portable binary image generated for CPU works only on CPU, an portable binary image generated on GPU works only on GPU, and an portable binary image generated on APU works only on APU.

At operation 402, the runtime on the target device determines whether the ISA for encoding the executable contained in exe section 210 matches the target device. The ISA matches if the processor on the target device is functionally equivalent to the processor on the original development device. For example, if the executable is compiled by an AMD HD 7970 GPU on a development device, then ISA matches if the processor on the target device is also HD 7970 GPU. If the ISA matches on the target device, then the runtime on the target device can execute the executable coded in accordance to the ISA.

At operation 406, if the ISA does not match, then the runtime checks whether the codegen output in CG output section 208 is recompilable on the target device. Two conditions must be satisfied for the codegen output to be recompiled on the target device. First, the processor on the target device belongs to the same generational family as the processor on the development device. For example, AMD HD 7970 and HD7990 belong to the same family of GPUs, so codegen output generated on a HD7970 on a development device will works on a HD7990 on a target device. The second condition is that the capabilities and resources of the target device processor are a super-set or equivalent of the development device processor.

If the codegen output in the portable image is recompilable on the target device processor, the JIT compiler associated with the runtime on the target device will recompile the codegen output into an executable encoded in accordance to the ISA specific to the target device processor at operation 408. At operation 404, the recompiled executable specific to the target device processor ISA is executed by the runtime.

If the codegen output is not recompilable on the target device, at operation 410, the runtime checks whether the LLVM IR in LLVMIR section 204 of portable binary image 200 is recompilable on the target device processor. Three conditions must be satisfied for the LLVM IR to be recompilable. First, the processor on the target device belongs to the same generational family as the processor on the development device. Second, the capabilities and resources of the target device processor are a super-set or equivalent of the development device processor. Third, any language specific requirements in the program source are valid on and supported by the target device processor.

If the LLVM IR of the portable binary is recompliable on the target device processor, the JIT compiler associated with the runtime on the target device will recompile the LLVM IR into a code output at operation 412. As described above, the new codegen output can be recompiled into an ISA-specific executable for the runtime to execute.

If the LLVM IR of the portable binary is not recompilable on the target device processor, at operation 414, the runtime checks whether the SPIR in SPIR section 206 of portable binary image 200 is recompilable on the target device processor. Two conditions are required for the SPIR to recompilable. First, the target device processor must support SPIR extension. Second, any language specific requirements in the program source are valid on and supported by the target device processor.

If the SPIR is recompilable on the target device processor, at operation 414, the

SPIR is recompiled into LLVM IR, which will ultimately be compiled into GPU-specific ISA or x86 specific executable on the target device processor.

If the SPIR is not recompilable on the target device processor, at operation 418, the runtime on the target device checks whether encoded source code 202 of portable image binary 200 is recompilable. Encoded source code 202 is recompilable if the program source language is valid for the target device processor. For example, if the program source code is written in OpenCL C language, then the source language if valid if the OpenCL C runtime runs on the target device processor.

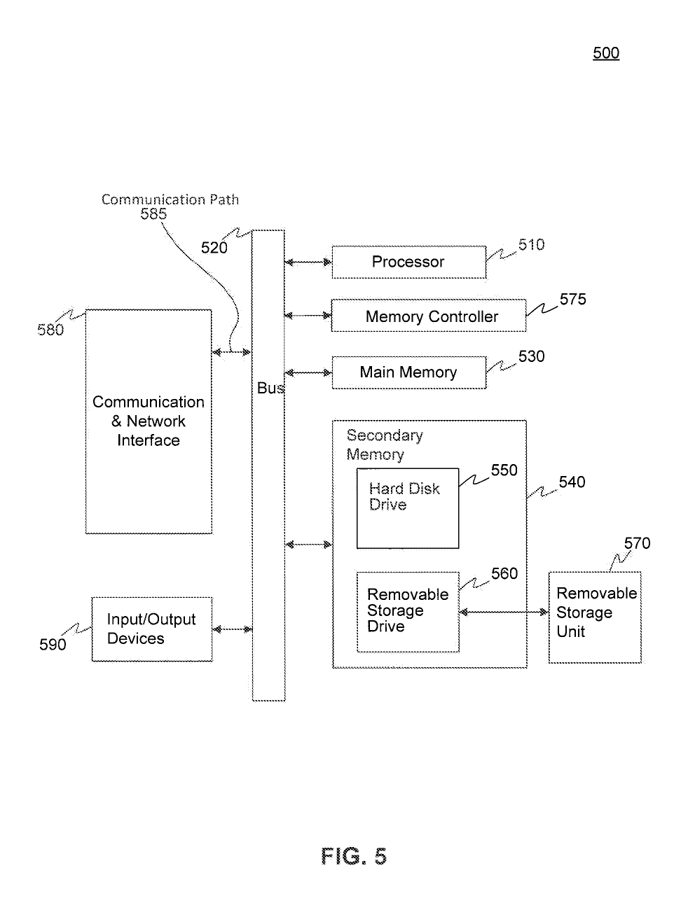

Various aspects of the disclosure can be implemented by software, firmware, hardware, or a combination thereof. FIG. 5 illustrates an example computer system 500 in which the contemplated embodiments, or portions thereof, can be implemented as computer-readable code. For example, the methods illustrated by flowcharts described herein can be implemented in system 500. Various embodiments are described in terms of this example computer system 500. After reading this description, it will become apparent to a person skilled in the relevant art how to implement the embodiments using other computer systems and/or computer architectures.

Computer system 500 includes one or more processors, such as processor 510. Processor 510 can be a special purpose or a general purpose processor, Processor 510 is connected to a communication infrastructure 520 (for example, a bus or network). Processor 510 may include a CPU, a Graphics Processing Unit (GPU), an Accelerated Processing Unit (APU), a Field-Programmable Gate Array (FPGA), Digital Signal Processing (DSP), or other similar general purpose or specialized processing units.

Computer system 500 also includes a main memory 530, and may also include a secondary memory 540. Main memory may be a volatile memory or non-volatile memory, and divided into channels. Secondary memory 540 may include, for example, non-volatile memory such as a hard disk drive 550, a removable storage drive 560, and/or a memory stick. Removable storage drive 560 may comprise a floppy disk drive, a magnetic tape drive, an optical disk drive, a flash memory, or the like. The removable storage drive 560 reads from and/or writes to a removable storage unit 570 in a well-known manner. Removable storage unit 570 may comprise a floppy disk, magnetic tape, optical disk, etc. which is read by and written to by removable storage drive 560. As will be appreciated by persons skilled in the relevant art(s), removable storage unit 570 includes a computer usable storage medium having stored therein computer software and/or data.

In alternative implementations, secondary memory 540 may include other similar means for allowing computer programs or other instructions to be loaded into computer system 500. Such means may include, for example, a removable storage unit 570 and an interface (not shown). Examples of such means may include a program cartridge and cartridge interface (such as that found in video game devices), a removable memory chip (such as an EPROM, or PROM) and associated socket, and other removable storage units 570 and interfaces which allow software and data to be transferred from the removable storage unit 570 to computer system 500.

Computer system 500 may also include a memory controller 575. Memory controller 575 includes functionalities of memory controller 112 in FIGS. 1A and 1B described above, and controls data access to main memory 530 and secondary memory 540. In some embodiments, memory controller 575 may be external to processor 510, as shown in FIG. 5. In other embodiments, memory controller 575 may also he directly part of processor 510. For example, many AMD™ and Intel™ processors use integrated memory controllers that are part of the same chip as processor 510 (not shown in FIG. 5).

Computer system 500 may also include a communications and network interface 580. Communication and network interface 580 allows software and data to be transferred between computer system 500 and external devices. Communications and network interface 580 may include a modem, a communications port, a PCMCIA slot and card, or the like. Software and data transferred via communications and network interface 580 are in the form of signals which may be electronic, electromagnetic, optical, or other signals capable of being received by communication and network interface 580. These signals are provided to communication and network interface 580 via a communication path 585. Communication path 585 carries signals and may be implemented using wire or cable, fiber optics, a phone line, a cellular phone link, an RF link or other communications channels.

The communication and network interface 580 allows the computer system 500 to communicate over communication networks or mediums such as LANs, WANs the Internet, etc. The communication and network interface 580 may interface with remote sites or networks via wired or wireless connections.

In this document, the terms “computer program medium,” “computer-usable medium” and “non-transitory medium” are used to generally refer to tangible media such as removable storage unit 570, removable storage drive 560, and a hard disk installed in hard disk drive 550. Signals carried over communication path 585 can also embody the logic described herein. Computer program medium and computer usable medium can also refer to memories, such as main memory 530 and secondary memory 540, which can be memory semiconductors (e.g. DRAMs, etc.). These computer program products are means for providing software to computer system 500.

Computer programs (also called computer control logic) are stored in main memory 530 and/or secondary memory 540. Computer programs may also be received via communication and network interface 580. Such computer programs, when executed, enable computer system 500 to implement embodiments as discussed herein. In particular, the computer programs, when executed, enable processor 510 to implement the disclosed processes, such as the steps in the methods illustrated by flowcharts discussed above. Accordingly, such computer programs represent controllers of the computer system 500. Where the embodiments are implemented using software, the software may be stored in a computer program product and loaded into computer system 500 using removable storage drive 560, interfaces, hard drive 550 or communication and network interface 480, for example.

The computer system 500 may also include input/output/display devices 490, such as keyboards, monitors, pointing devices, etc.

It should be noted that the simulation, synthesis and/or manufacture of various embodiments of this invention may be accomplished, in part, through the use of computer readable code, including general programming languages (such as C or C++), hardware description languages (HDL) such as, for example, Verilog HDL, VHDL, Altera HDL (AHDL), or other available programming and/or schematic capture tools (such as circuit capture tools). This computer readable code can be disposed in any known computer-usable medium including a semiconductor, magnetic disk, optical disk (such as CD-ROm DVD-ROM). As such, the code can be transmitted over communication networks including the Internet. It is understood that the functions accomplished and/or structure provided by the systems and techniques described above can be represented in a core that is embodied in program code and can be transformed to hardware as part of the production of integrated circuits.

The embodiments are also directed to computer program products comprising software stored on any computer-usable medium. Such software, when executed in one or more data processing devices, causes a data processing device(s) to operate as described herein or, as noted above, allows for the synthesis and/or manufacture of electronic devices (e.g., ASICs, or processors) to perform embodiments described herein. Embodiments employ any computer-usable or -readable medium, and any computer-usable or -readable storage medium known now or in the future. Examples of computer-usable or computer-readable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage devices, etc.), and communication mediums (e.g., wired and wireless communications networks, local area networks, wide area networks, intranets, etc.). Computer-usable or computer-readable mediums can include any form of transitory (which include signals) or non-transitory media (which exclude signals). Non-transitory media comprise, by way of non-limiting example, the aforementioned physical storage devices (e.g., primary and secondary storage devices).

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

1. A method, comprising:
compiling a program source code into a first executable specific to a first instruction set architecture (ISA);
compiling the program source code into a code generator output; and
combining the first executable and the code generator output into a portable binary image, wherein the code generator output is configured to be compiled into a second executable specific to a second ISA at runtime.

2. The method of claim 1, further comprising:
compiling the program source code into an immediate representation; and
combining the immediate representation into the portable binary image, wherein, at runtime, the immediate representation can be compiled into a second code generator output, and the second code generator output can be compiled into the second executable.

3. The method of claim 2, wherein the immediate representation comprises a low level virtual machine immediate representation (LLVM IR).

4. The method of claim 1, further comprising:
compiling the program source code into an intermediate representation; and
combining the intermediate representation into the portable binary image, wherein, at runtime, the intermediate representation can be compiled into an immediate representation, the immediate representation can be compiled into a second code generator output, and the second code generator output can be compiled into the second executable.

5. The method of claim 4, wherein the intermediate representation comprises a standard portable intermediate representation (SPIR).

6. The method of claim 1, further comprising:
compiling the program source code into an encoded source code; and
combining the encoded source code into the portable binary image, wherein, at runtime, the encoded source code can be compiled into an immediate representation, the immediate representation can be compiled into a second code generator output, and the second code generator output can be compiled into the second executable.

7. A development system, comprising:
a memory;
a processor;
a compiler, implemented on the processor, configured to:
compile a program source code into a first executable specific to a first instruction set architecture (ISA);
compile the program source code into a code generator output; and
combine the ISA and the code generator output into a portable binary image, wherein, at runtime, the code generator output can be compiled into a second executable specific to a second ISA.

8. The system of claim 7, wherein the compiler is further configured to:
compile the program source code into an immediate representation; and
combine the immediate representation into the portable binary image, wherein, at runtime, the immediate representation can be compiled into a second code generator output, and the second code generator output can be compiled into the second executable.

9. The system of claim 8, wherein the immediate representation comprises a low level virtual machine immediate representation (LLVM IR).

10. The system of claim 7, wherein the compiler is further configured to:
compile the program source code into an intermediate representation; and
combine the intermediate representation into the portable binary image, wherein, at runtime, the intermediate representation can be compiled into an immediate representation, the immediate representation can be compiled into a second code generator output, and the second code generator output can be compiled into the second executable.

11. The system of claim 10, wherein the intermediate representation comprises a standard portable intermediate representation (SPIR).

12. The system of claim 7, wherein the compiler is further configured to:
compile the program source code into an encoded source code; and
combine the encoded source code into the portable binary image, wherein, at runtime, the encoded source code can be compiled into an immediate representation, the immediate representation can be compiled into a second code generator output, and the second code generator output can be compiled into the second executable.

13. A non-transitory computer-readable medium having instructions stored thereon, execution of which by a processor causes the processor to perform operations comprising:
compiling a program source code into a first executable specific to a first instruction set architecture (ISA);
compiling the program source code into a code generator output; and
combining the ISA and the code generator output into a portable binary image, wherein, at runtime, the code generator output can be compiled into a second executable specific to a second ISA.

14. The non-transitory computer-readable medium of claim 13, the operations further comprising:
compiling the program source code into an immediate representation; and
combining the immediate representation into the portable binary image, wherein, at runtime, the immediate representation can be compiled into a second code generator output, and the second code generator output can be compiled into the second executable.

15. The non-transitory computer-readable medium of claim 13, the operations further comprising:
compiling the program source code into an intermediate representation; and
combining the intermediate representation into the portable binary image, wherein, at runtime, the intermediate representation can be compiled into an immediate representation, the immediate representation can be compiled into a second code generator output, and the second code generator output can be compiled into the second executable.

16. The non-transitory computer-readable medium of claim 13, the operations further comprising:
compiling the program source code into an encoded source code; and
combining the encoded source code into the portable binary image, wherein, at runtime, the encoded source code can be compiled into an immediate representation, the immediate representation can be compiled into a second code generator output, and the second code generator output can be compiled into the second executable.

17. A method, comprising:
loading a portable binary image into a runtime running on a processor, the portable binary image comprising an executable specific to an instruction set architecture (ISA) in a first section of the portable binary image and a code generator output in a second section of the portable binary image;
recompiling the code generator output into the first section responsive to the ISA not matching the processor's ISA; and
executing the first section by the runtime.

18. The method of claim 17, wherein the portable binary image further comprises an immediate representation in a third section, and the method further comprising:
recompiling the immediate representation section into the second section responsive to the code generator output not being recompilable on the processor.

19. The method of claim 18, wherein the portable binary image further comprises an intermediate representation in a fourth section, and the method further comprising:
recompiling the intermediate representation into the third section responsive to the immediate representation not being recompilable on the processor.

20. The method of claim 19, wherein the portable binary image further comprises an encoded source code in a fifth section, and the method further comprising:
recompiling the encoded source code into the third section responsive to the intermediate representation not being recompilable on the processor.
